(19) United States
(12) Patent Application Publication
(10) Pub. No.: US 2013/0311357 A1
(43) Pub. Date: Nov. 21, 2013

(54) METHODS FOR FACILITATING ONLINE TRANSACTIONS INVOLVING A PLURALITY OF UNIQUE CURRENCIES

(71) Applicant: WOLFGANG KRING, Pasadena, CA (US)

(72) Inventor: WOLFGANG KRING, Pasadena, CA (US)

(21) Appl. No.: 13/472,474

(22) Filed: May 16, 2012

(51) Int. Cl. G06Q 20/10

(52) U.S. Cl. 705/39

(57) ABSTRACT

The invention discloses methods for allowing a user to optimize online purchases of goods or services by providing real-time exchange data between a plurality of relevant currencies. Users may opt to put off a purchase or payment of a purchase based on currency exchange trajectories as presented at the time of “check out” from an Internet purchase.

### FIELD AND BACKGROUND OF THE INVENTION

The present invention, in some embodiments thereof, relates to methods for providing a user real-time currency conversion information prior to completing an online transaction. In some embodiments, a user may hedge his/her purchase by choosing a later payment date to allow for an improved conversion between the user's bank account currency and the currency associated with a product or service purchased by said user.

One of most significant revolutions in business has revolved around Internet commerce. Online purchases in the hundreds of billions of dollars have allowed people to use computers, mobile devices, or similar computing devices in order to buy and sell merchandise and services. Whereas in the past, one might have to travel to a store to buy clothes, today one can easily go online and in the matter of minutes complete a purchase, with the goods arriving in a day or two.

This revolution in commerce has not been limited by borders. Internet access throughout the world, including in relative closed countries like China, is on the rise and over 1 billion people have some level of Internet access. A Frenchman can order a bicycle in Chile and have it sent to South Africa in preparation for a family trip—all of the actions being done in the luxury of his home with the aid of a computing device with a graphical user interface. This ease of cross-border purchase has allowed for enormous growth in international sales and commerce.

One problem that has arisen with cross-border online sales has to do with exchange rates. The Euro was introduced in large part to remove the constant need for currency exchanges between francs, drachmas, liras, and the like. But today, an Indian woman with a rupee account wishing to buy a tea set from a British firm still faces the issue of conversion from her local bank currency and the online sale currency, in this case the pound. People are often ignorant of exchange rates and very few know the exact exchange rate at the time of an online purchase. Additionally, exchange rates, while officially fixed by national currency bodies like the Fed or the Bank of England, the final exchange rate may include bank or other service fees (see http://www.xe.com/ for example of publicly quoted exchange rates). In order for world commerce to be successful and fair, purchasers must know the actual exchange rate they will pay upon purchase of a product or service. Knowing such details prior to purchase allows users to both compare prices on a single fixed currency, generally their own base currency, as well as to make judicial decisions with respect to use of money.

U.S. Pat. No. 6,829,590 to Greener provides a method and system to implement risk management of foreign exchange of currency related to an online transaction. According to the present invention an exchange price and a tolerance parameter can be determined for a foreign currency as the foreign currency relates to a base currency. A computer system can receive a spot price relating to a market price for exchange of a foreign currency and compare the spot price with the tolerance parameter. The system can modify the exchange price if spot price exceeds the tolerance parameter. In addition, the system can receive information including the base currency amount involved in an online transaction and transmit the base currency amount and the foreign currency amount, wherein the foreign currency amount is derived according to the exchange price. If desired, a first tolerance parameter and a second tolerance parameter can be utilized, wherein a rise in the spot price is compared to the first tolerance parameter and a fall in the spot price is compared to the second tolerance parameter. In addition, the magnitude of the first tolerance parameter does not need to be equal to the magnitude of the second tolerance parameter. A rise in the spot price can be compared to the tolerance parameter such that the exchange price is modified if the spot price is higher than the tolerance parameter. Similarly, only a fall of the spot price can be compared to the tolerance parameter such that the exchange price is modified if the spot price is lower than the tolerance parameter. Additionally, a spot price can be determined and compared to the tolerance level at predetermined periods of time. An original tolerance level can be modified to create a new tolerance level, if the spot price exceeds the original tolerance level.

U.S. Pat. No. 7,747,475 to Bowman et al teaches techniques for intelligent selection of a currency preference for a user and a conversion of monetary values to the preferred currency for transactions entered into by the user. The conversion is performed using a firm exchange rate that is derived from a market exchange rate, but guaranteed for a period of time during which the transaction is anticipated to be completed.

U.S. Pat. No. 7,979,347 to Greener, et al. contemplates a risk management system for facilitating an e-commerce transaction wherein the participants to the transaction engage in commerce using different currencies. An automated sales risk management system facilitates a transaction by providing a price of a transaction which incorporates aggregated costs related to the transaction into a price made available to the participants. A currency risk management system can receive an amount relating to a deliverable involved in a transaction and determines an aggregated cost of the transaction. Aggregated cost can include a cost of credit, a cost for exchange of currency, a cost of insurance, processing fees, or other associated costs. Insurance can be monitored and a determination can be made regarding whether a participant has adequate insurance to cover a proposed transaction. The present invention also provides for risk associated with online transactions to be categorized and transferred.

U.S. Pat. No. 8,055,582 to Giacomo teaches a method and apparatus for facilitating online payment transactions in multiple currencies between participants of a network-based transaction facility are described. In one embodiment, an exchange rate associated with a currency is stored in a database. The exchange rate is received from a third party system and is associated with a rate expiration date. One or more payment transactions conducted in the currency are also stored. A determination is made whether a determinable time period has expired, whereby the determinable time period is set to expire prior to the rate expiration date. In response to the determinable time period expiring, instructions are sent to the third party system to execute trades on the one or more payment transactions using the stored exchange rate.

### SUMMARY OF THE INVENTION

It is therefore a purpose of the present invention, in some embodiments, to provide an online purchaser with exchange rate data between the currency associated with user's banks account and the currency associated with the product or service under consideration for acquisition. In some embodiments, user may choose to hedge currency exchange rates by putting off a payment of purchase for a predetermined period of time.

The invention includes a method for allowing online purchases conducted in a plurality of currencies, including: creating a database of users, wherein the database minimally includes user names, user bank account numbers and authorization details, the currencies associated with the bank account numbers, and the preferred methods of payment for online transactions defined by the users; allowing a user to initiate an online transaction; allowing the user to indicate that he wishes to pay for the online transaction; determining via an IP address associated with a computing device employed by the user the physical location of the user at the time of the transaction; determining a first currency used in the online transaction, wherein the first currency is associated with an item to be purchased by the user in the online transaction; presenting to the user a present exchange rate between the first currency and a second currency, wherein the second currency is associated with a predetermined bank account associated with the user in the database; presenting the user with a plurality of methods of paying for the online transaction; and, allowing the user to complete the online transaction.

In one aspect of the method, the predetermined bank account is selected by the user from a plurality of bank accounts stored in the database.

In another aspect of the method, the first currency is the dollar.

In another aspect of the method, the first currency is the euro.

In another aspect of the method, the authorization details include a digital signature associated with each user.

In another aspect of the method, the allowing the user to indicate that he wishes to pay is performed in a one-click action on an icon presented on a graphical user interface associated with the computing device.

In another aspect of the method, the item to be purchased is selected from consumer products, computer equipment, books, clothes, travel, transportation, electronic gadgets, cell phones, a service, and housing goods.

In another aspect of the method, the online purchase is performed with an online retailer.

The invention provides for a method for allowing efficient online purchases conducted in a plurality of currencies, including: creating a database of users, wherein the database minimally includes user names, user bank account numbers and authorization details, the currencies associated with the bank account numbers, and the preferred methods of payment for online transactions defined by the users; allowing a user to initiate an online transaction; allowing the user to indicate that he wishes to pay for the online transaction; determining via an IP address associated with a computing device employed by the user the physical location of the user at the time of the transaction; determining a first currency used in the online transaction, wherein the first currency is associated with an item to be purchased by the user in the online transaction; presenting to the user a present exchange rate between the first currency and a second currency, wherein the second currency is associated with a predetermined bank account associated with the user in the database; presenting to the user historical data on the exchange rate between the first currency and the second currency; allowing the user to choose to pay for the transaction immediately or to postpone payment of the transaction for a predetermined period of time; and, allowing the user to complete the online transaction.

In one aspect of the method, there is additionally the step of presenting to the user recent historical information on the exchange rate between the first currency and the second currency.

In another aspect of the method, the first currency is the dollar and the second currency is the euro.

In another aspect of the method, the first currency is the euro and the second currency is the dollar.

In another aspect of the method, the authorization details include a digital signature associated with each user.

In another aspect of the method, the allowing the user to indicate that he wishes to pay is performed in a one-click action on an icon presented on a graphical user interface associated with the computing device.

In another aspect of the method, the item is selected from consumer products, computer equipment, books, clothes, travel, transportation, electronic gadgets, cell phones, a service, and housing goods.

In another aspect of the method, the online purchase is performed with an online retailer.

The invention additionally includes a method for allowing efficient online purchases conducted in a plurality of currencies, including: creating a database of users, wherein the database minimally includes user names, user bank account numbers and authorization details, the currencies associated with the bank account numbers, and the preferred methods of payment for online transactions defined by the users; allowing a user from the users to initiate an online transaction; allowing the user to indicate that he wishes to pay for the online transaction; determining via an IP address associated with a computing device employed by the user the physical location of the user at the time of the transaction; determining a first currency used in the online transaction, wherein the first currency is associated with an item to be purchased by the user in said online transaction; presenting to the user a present exchange rate between the first currency and a second currency, wherein the second currency is associated with a bank account associated with the user in said database; presenting an optical signal on a graphical user interface associated with a computing device used by user in the online transaction, wherein the optical signal provides the user with information regarding the advisability of completing said transaction; allowing the user to choose to pay for said transaction or to postpone payment of the transaction for a predetermined period of time; and, allowing the user to complete the online transaction.

In one aspect of the method, the optical signal may include a predetermined shape and a predetermined color.

In another aspect of the method, the optical signal is red in color if said user is advised not to the online transaction.

In another aspect of the method, the optical signal is green in color if the user is advised to complete the online transaction.

Unless otherwise defined, all technical and/or scientific terms used herein have the same meaning as commonly understood by one of ordinary skill in the art to which the invention pertains. Exchange rates as used in the instant invention may be fixed by governments, banks, other bodies, and may in some embodiments include additional fees such as exchange or processing fees. “Optical signal” may generally refer to an icon or other feature that may appear on a graphical user interface of a computing device so as to alert a user for some important information. A “computing device” may include computers, laptops, cell phones, tablet computers, handheld wireless devices, and other devices that may connect to the Internet.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced. It is noted that similar elements in various drawings will have the same number, advanced by the appropriate multiple of 100.

In the drawings:

FIG. 1 shows a method associated with an embodiment of the instant invention;

FIG. 2 shows an alternative method associated with an embodiment of the instant invention;

FIG. 3 shows yet another method associated with an embodiment of the instant invention; and,

FIG. 4 which shows a schematic view of an Example of an embodiment of the present invention.

### DESCRIPTION OF SPECIFIC EMBODIMENTS OF THE INVENTION

The present invention, in some embodiments thereof, relates to methods for the efficient transaction of goods, services and funds when a plurality of unique currencies are involved in an Internet-based activity. The instant invention generally includes a database that may hold information regarding to a plurality of users. For a typical user, bank names, associated account numbers, and authorization details are included in the database. As an individual may have a plurality of bank accounts in one or more banks, and these accounts may be in different currency types, the instant invention allows a user to determine which account associated with which currency is best for completing the financial portion of an online transaction.

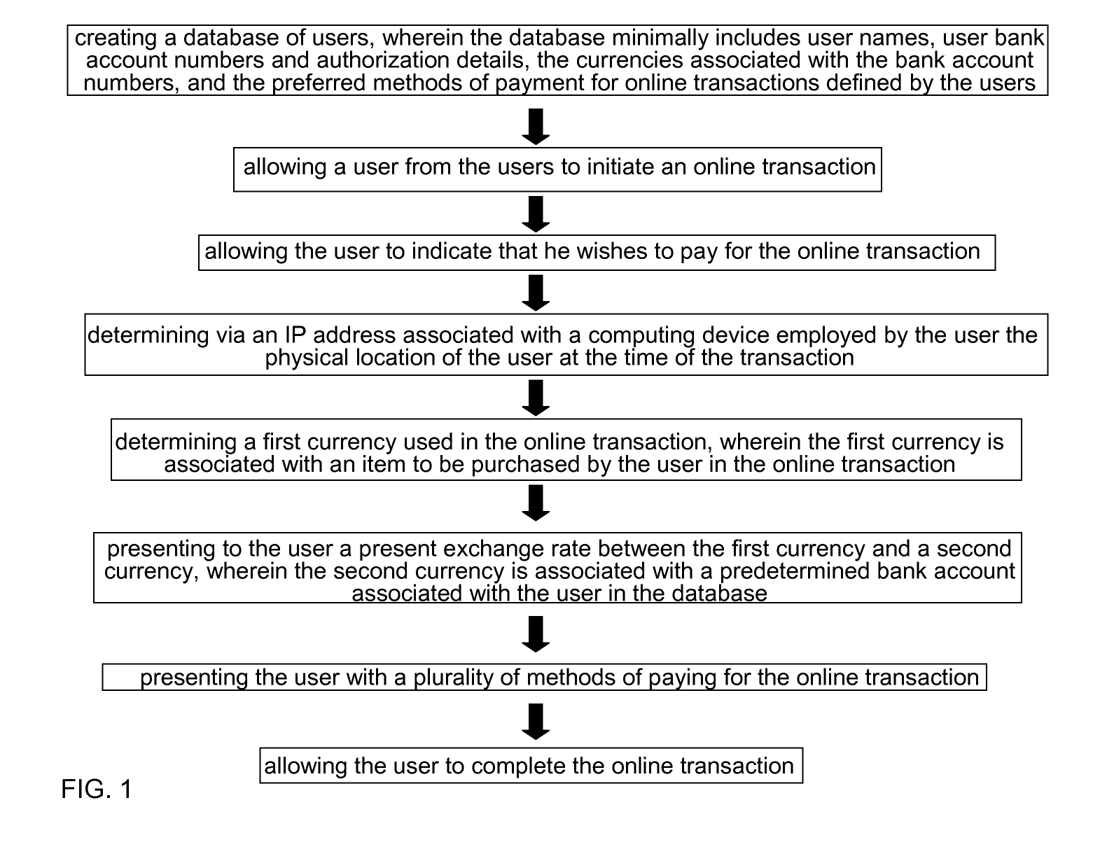

For purposes of better understanding some embodiments of the present invention, as illustrated in FIGS. 1-3 of the drawings, reference is first made to FIG. 1.

### First Embodiment

FIG. 1 shows an associated with the instant invention. The method includes the following: creating a database of users, wherein the database minimally includes user names, user bank account numbers and authorization details, the currencies associated with the bank account numbers, and the preferred methods of payment for online transactions defined by the users; allowing a user from the users to initiate an online transaction; allowing the user to indicate that he wishes to pay for the online transaction; determining via an IP address associated with a computing device employed by the user the physical location of the user at the time of the transaction; determining a first currency used in the online transaction, wherein the first currency is associated with an item to be purchased by the user in the online transaction; presenting to the user a present exchange rate between the first currency and a second currency, wherein the second currency is associated with a predetermined bank account associated with the user in the database; presenting the user with a plurality of methods of paying for the online transaction; and, allowing the user to complete the online transaction. Determination of the IP address may be used as a control to identify the user as well as to determine his/her geographical location. Whereas some websites (for example www.sears.com) automatically convert prices into local currencies of those who come to shop at their sites, the instant invention leaves prices in the original currency. The instant invention may provide real-time or very recent currency exchange rates between the currency associated with the item of interest and the bank account the user has identified as being the one he/she wishes to use. By doing so, the instant invention gives a user the flexibility and control to choose which account best serves his/her needs. The foreign exchange (“forex”) data may be provided by any appropriate source including governmental or bank sources. The exchange rate presented to user may additionally factor in bank and similar charges.

### Second Embodiment

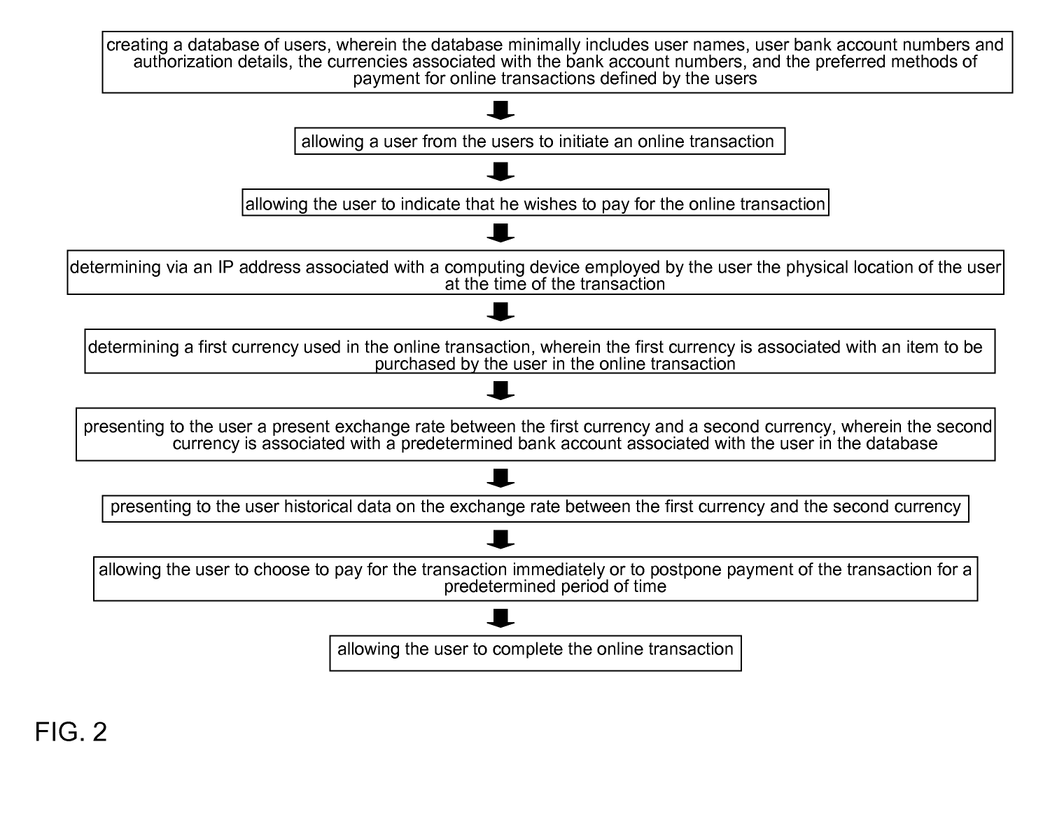

Attention is turned to FIG. 2 which shows a flowchart of an embodiment associated with the instant invention. The method calls for creating a database of users, wherein the database minimally includes user names, user bank account numbers and authorization details, the currencies associated with the bank account numbers, and the preferred methods of payment for online transactions defined by the users; allowing a user from the users to initiate an online transaction; allowing the user to indicate that he wishes to pay for the online transaction; determining via an IP address associated with a computing device employed by the user the physical location of the user at the time of the transaction; determining a first currency used in the online transaction, wherein the first currency is associated with an item to be purchased by the user in the online transaction; presenting to the user a present exchange rate between the first currency and a second currency, wherein the second currency is associated with a predetermined bank account associated with the user in the database; presenting to the user historical data on the exchange rate between the first currency and the second currency; allowing the user to choose to pay for the transaction immediately or to postpone payment of the transaction for a predetermined period of time; and, allowing the user to complete the online transaction. In this embodiment, a user may hedge a currency exchange to his/her advantage. By presenting a user historical data (which may be measured in hours to days to weeks or months) on exchange rates between the two relevant currencies (of the item or service of interest and of the selected bank account), the instant invention allows a user to decide if it is in his/her interest to pay now as the exchange rate is getting “worse” for his paying currency or if the recent historical data suggest that his/her currency is getting stronger, then he/she may choose to buy the item or service but to push off payment for a predetermined period of time, which may be a day, week, or month, for example. A service provider or a bank may take a fee for the hedging service, as the service provider or bank may pay immediately and then charge the indicated customer account at a later time. By providing a user with relevant historical exchange rate data, the instant invention allows a user to make careful and wise decisions with respect to deployment of capital. If an exchange rate is working towards to the user's favor, a hedging option may be employed wherein payment is delayed to allow for further strengthening of the user's selected currency, so as to minimize his “true cost” or purchase.

### Third Embodiment

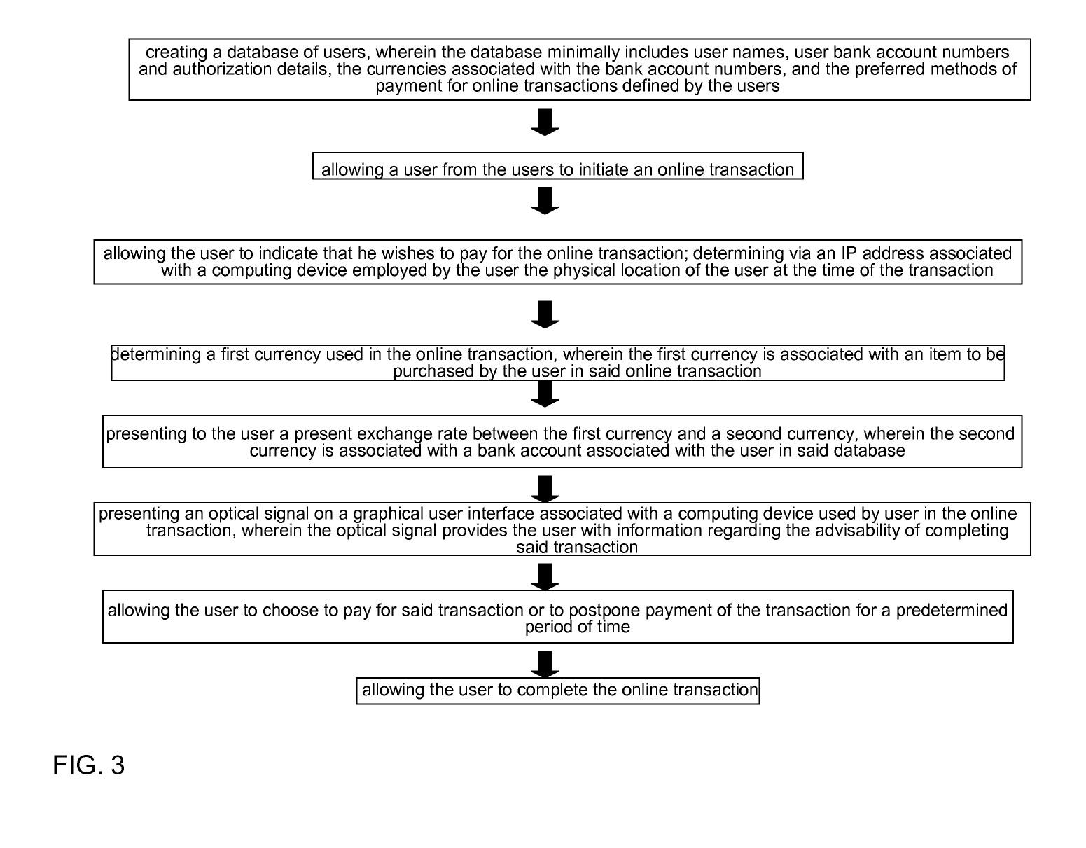

Attention is turned to FIG. 3 which shows a schematic view of an embodiment of the instant invention. The figure shows a method for allowing efficient online purchases when a plurality of currencies is involved. The method includes the following: creating a database of users, wherein the database minimally includes user names, user bank account numbers and authorization details, the currencies associated with the bank account numbers, and the preferred methods of payment for online transactions defined by the users; allowing a user from the users to initiate an online transaction; allowing the user to indicate that he wishes to pay for the online transaction; determining via an IP address associated with a computing device employed by the user the physical location of the user at the time of the transaction; determining a first currency used in the online transaction, wherein the first currency is associated with an item to be purchased by the user in said online transaction; presenting to the user a present exchange rate between the first currency and a second currency, wherein the second currency is associated with a bank account associated with the user in said database; presenting an optical signal on a graphical user interface associated with a computing device used by user in the online transaction, wherein the optical signal provides the user with information regarding the advisability of completing said transaction; allowing the user to choose to pay for said transaction or to postpone payment of the transaction for a predetermined period of time; and, allowing the user to complete the online transaction. The second embodiment assumed some level of sophistication with respect to understanding forex data. In the present embodiment, currency trends are shown through the agency of optical signal which indicates that the exchange rate is good or bad relative to recent historical trends. Thus, if the pound is weakening against the dollar and a person with a pound-based account wishes to buy a dollar-based service, the present embodiment would show a red circle (for example) which will suggest to user that the exchange rate is not working in his favor. The user may choose to postpone the purchase, make the purchase in a dollar-based account or go ahead with the purchase for lack of alternative. If the exchange rate is relatively strong as compared to recent historical data, a green circle may be present on the graphical user interface of user's computing device. Such a situation might encourage the user to go through with the transaction as the exchange rate is strong and in his/her favor.

It is expected that during the life of a patent maturing from this application variable mold technologies will be developed and the scope of the term of the invention is intended to include all such new technologies a priori.

As used herein the term “about” refers to ±10%.

The terms “comprises”, “comprising”, “includes”, “including”, “having” and their conjugates mean “including but not limited to”.

The term “consisting of means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

All technical terms may have their normal meaning as applied to the art unless otherwise specified. “Infrastructure elements” may refer to cables, pipes, wires, and the like traditionally used in construction. Such cables, pipes, and wires may move water, telephone connections, electricity, TV connections or other items.

### EXAMPLE

An individual in India has bank accounts in rupee, dollar, and pound denominations. She has entered her personal and bank data, with validation signature example, into an online database run by an online payment company. While shopping online, she has come across a Greek vacation which she wishes to purchase for her family. The provider is in Greece and the online prices are quoted in Euros. When the time has come to check out, the online payment company shows this user exchange rate values between Euros and her three currencies: euro-rupee, euro-dollar, and euro-pound. At her request, recent historical data on the three exchange rates are present. The user notices that the pound is strengthening against the euro, while the dollar and rupee are weakening. The user chooses to purchase the Greek vacation with her pound account but requests a fifteen day delay in payment. The online payment company charges a small fee for this service and the transaction is completed. The woman has purchased the Greek vacation and when she is charged, she will have minimized the number of pounds per Euro paid for the vacation through a successful hedging strategy as described in the second embodiment above.

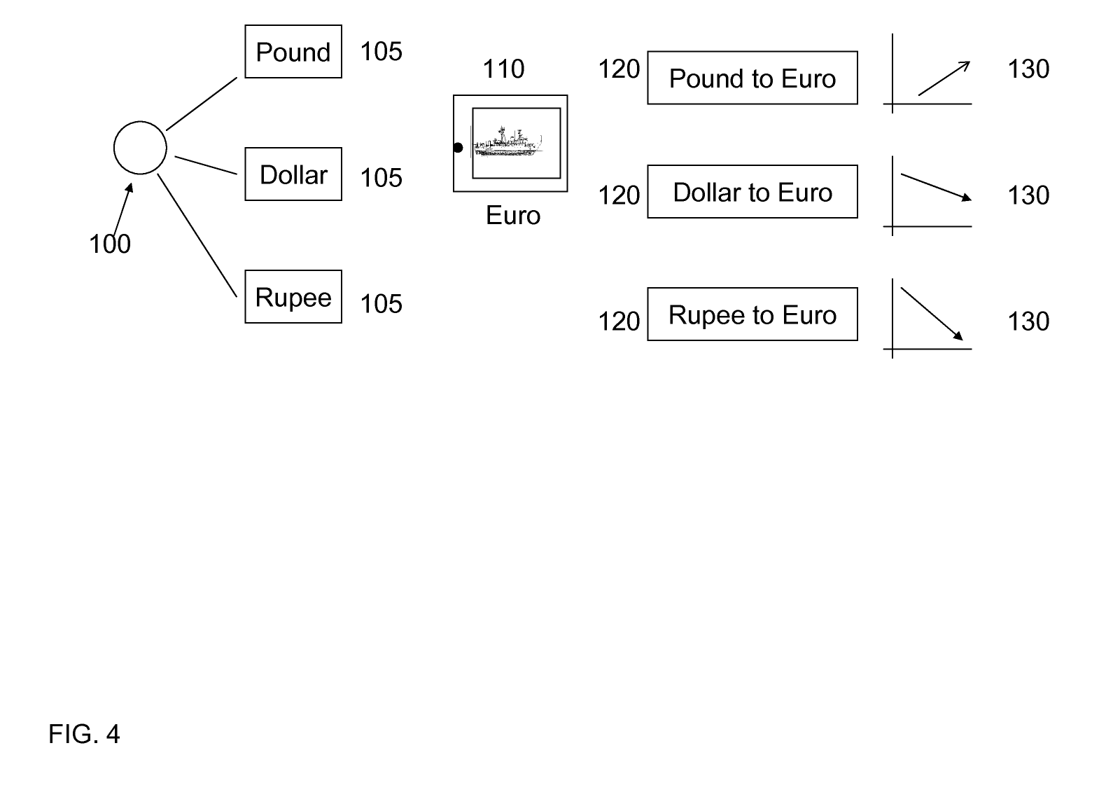

The above example is schematically summarized in FIG. 4. A user 100 has three bank accounts 105 in various denominations as shown. User 100 wishes to buy an online item 110 represented as a Greek vacation. User is presented with exchange rate data 120 between Euro, the denomination of the vacation, and her three bank accounts 105. Additionally, historical data 130 are presented for the Euro against the three currencies related to bank accounts 105 owned by user 100. As the pound is the only currency showing an improved position relative to the Euro (as suggested by the line increasing from left to right in graph 130), user 100 makes her purchase in pounds and hedges her purchase by requesting a 15 day delay in payment.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination. The instant invention has equal applicability for credit card purchases, check purchases, as well as online transfers. The instant invention may be applied on a plurality of merchant websites, and in some embodiments the provider of the methods herein described may have its own pay icon on the websites of said merchant websites. A user thus would choose that which he wishes to buy and then click on the appropriate icon to begin the payment program as described in the methods above. By providing accurate forex information, the instant invention can lead to the savings of billions of consumer dollars by making obligate currency transactions online as efficient as possible.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. The present invention could be employed for non-Internet bank transaction or services provided by a “brick and mortar” store as well

Various embodiments and aspects of the present invention as delineated hereinabove and as claimed in the claims section below find experimental support in the following example.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

1. A method for allowing online purchases conducted in a plurality of currencies, including:
creating a database of users, wherein said database minimally includes user names, user bank account numbers and authorization details, the currencies associated with said bank account numbers, and the preferred methods of payment for online transactions defined by said users;
allowing a user from said users to initiate an online transaction;
allowing said user to indicate that he wishes to pay for said online transaction;
determining via an IP address associated with a computing device employed by said user the physical location of said user at the time of said transaction;
determining a first currency used in said online transaction, wherein said first currency is associated with an item to be purchased by said user in said online transaction;
presenting to said user a present exchange rate between said first currency and a second currency, wherein said second currency is associated with a predetermined bank account associated with said user in said database;
presenting said user with a plurality of methods of paying for said online transaction; and,
allowing said user to complete said online transaction.

2. The method according to claim 1, wherein said predetermined bank account is selected by said user from a plurality of bank accounts stored in said database.

3. The method according to claim 1, wherein said first currency is the dollar.

4. The method according to claim 1, wherein said first currency is the euro.

5. The method according to claim 1, wherein said authorization details include a digital signature associated with each user.

6. The method according to claim 1, wherein said allowing said user to indicate that he wishes to pay is performed in a one-click action on an icon presented on a graphical user interface associated with said computing device.

7. The method according to claim 1, wherein said item to be purchased is selected from consumer products, computer equipment, books, clothes, travel, transportation, electronic gadgets, cell phones, a service, and housing goods.

8. The method according to claim 1, wherein said online purchase is performed with an online retailer.

9. A method for allowing efficient online purchases conducted in a plurality of currencies, including:
creating a database of users, wherein said database minimally includes user names, user bank account numbers and authorization details, the currencies associated with said bank account numbers, and the preferred methods of payment for online transactions defined by said users;
allowing a user from said users to initiate an online transaction;
allowing said user to indicate that he wishes to pay for said online transaction;
determining via an IP address associated with a computing device employed by said user the physical location of said user at the time of said transaction;
determining a first currency used in said online transaction, wherein said first currency is associated with an item to be purchased by said user in said online transaction;
presenting to said user a present exchange rate between said first currency and a second currency, wherein said second currency is associated with a predetermined bank account associated with said user in said database;
presenting to said user historical data on the exchange rate between said first currency and said second currency;
allowing said user to choose to pay for said transaction immediately or to postpone payment of said transaction for a predetermined period of time; and,
allowing said user to complete said online transaction.

10. The method according to claim 9, further including the step of presenting to said user recent historical information on said exchange rate between said first currency and said second currency.

11. The method according to claim 9, wherein said first currency is the dollar and said second currency is the euro.

12. The method according to claim 9, wherein said first currency is the euro and said second currency is the dollar.

13. The method according to claim 9, wherein said authorization details include a digital signature associated with each user.

14. The method according to claim 9, wherein said allowing said user to indicate that he wishes to pay is performed in a one-click action on an icon presented on a graphical user interface associated with said computing device.

15. The method according to claim 9, wherein said item is selected from consumer products, computer equipment, books, clothes, travel, transportation, electronic gadgets, cell phones, a service, and housing goods.

16. The method according to claim 9, wherein said online purchase is performed with an online retailer.

17. A method for allowing efficient online purchases conducted in a plurality of currencies, including:
creating a database of users, wherein said database minimally includes user names, user bank account numbers and authorization details, the currencies associated with said bank account numbers, and the preferred methods of payment for online transactions defined by said users;
allowing a user from said users to initiate an online transaction;
allowing said user to indicate that he wishes to pay for said online transaction;
determining via an IP address associated with a computing device employed by said user the physical location of said user at the time of said transaction;
determining a first currency used in said online transaction, wherein said first currency is associated with an item to be purchased by said user in said online transaction;
presenting to said user a present exchange rate between said first currency and a second currency, wherein said second currency is associated with a bank account associated with said user in said database;
presenting an optical signal on a graphical user interface associated with a computing device used by user in said online transaction, wherein said optical signal provides said user with information regarding the advisability of completing said transaction;
allowing said user to choose to pay for said transaction or to postpone payment of said transaction for a predetermined period of time; and,
allowing said user to complete said online transaction.

18. The method according to claim 17, wherein said optical signal may include a predetermined shape and a predetermined color.

19. The method according to claim 18, wherein said optical signal is red in color if said user is advised not to said online transaction.

20. The method according to claim 18, wherein said optical signal is green in color if said user is advised to complete said online transaction.
